(19) United States
(12) Patent Application Publication
(10) Pub. No.: US 2014/0032486 A1
(43) Pub. Date: Jan. 30, 2014

(54) SELECTIVE PUBLICATION OF COLLABORATION DATA

(71) Applicants: Rajeev Sharma, Ghaziabad (IN); Narinder Beri, Jalandhar (IN); Yash Kumar Gupta, Agra (IN)

(72) Inventors: Rajeev Sharma, Ghaziabad (IN); Narinder Beri, Jalandhar (IN); Yash Kumar Gupta, Agra (IN)

(21) Appl. No.: 12/127,487

(22) Filed: May 27, 2008

(51) Int. Cl. G06F 17/30; G06F 7/04

(52) U.S. Cl. 707/608; 726/19; 707/E17.001; 707/661; 707/802

(57) ABSTRACT

Various embodiments described herein each include one or more of systems, methods, data structures, and software to replicate a document or workflow workspace, including comments and other data added by document or workflow participants. Some embodiments allow participants to create, view, and manipulate public comments and other actions and private comments and other actions addressed specifically to individual participants, but prevent participants from viewing comments addressed only to one or more other participants. In some embodiments, the document may be distributed to participants via whatever means are convenient. The document may contain knowledge of a comment repository holding comments or other workflow data. Some embodiments include downloading comments and other data from a repository, identifying which comments and other data is intended for display to a viewing participant, and displaying the identified comments and other data.

### BACKGROUND INFORMATION

Many documents are generated in today's electronic society. These documents are often created by one individual, but are subject of review by others. Documents to be reviewed are commonly created and then forwarded to others for review. Such reviewers typically make corrections and additions to the document under review and may add comments, markups, and other annotations. The modified document is then sent back to the document creator. The document creator then has the task of sorting through each of possibly many modified document copies and consolidating the comments into a single copy of the document. Some comments and modifications may be the same between the modified document copies, but the creator of the document still needs to sort through all of the comments and make such a determination. Reviewers making the same modification or comment are also duplicating their efforts. Further, keeping track of a source of the modifications and comments becomes increasingly difficult as the number of reviewers increases. However, in some instances, one reviewer may want to make a comment or addition that would available for all reviewers to see.

### BRIEF DESCRIPTION OF THE DRAWINGS

FIG. 1 is a block diagram of a system according to an example embodiment.

FIG. 2 is a block diagram of system elements according to an example embodiment.

FIG. 3 is a user interface illustration according to an example embodiment.

FIG. 4 is a user interface illustration according to an example embodiment.

FIG. 5 is a user interface illustration according to an example embodiment.

FIG. 6 is a block diagram of a data structure according to an example embodiment.

FIG. 7 illustrates related database tables according to an example embodiment.

FIG. 8 is a block diagram of a computing device according to an example embodiment.

FIG. 9 is a block flow diagram of a method according to an example embodiment.

FIG. 10 is a block flow diagram of a method according to an example embodiment.

FIG. 11 is a block flow diagram of a method according to an example embodiment.

### DETAILED DESCRIPTION

Various embodiments described herein each include one or more of systems, methods, data structures, and software to replicate a document or workflow workspace, including comments and other data added by document or workflow participants. Some embodiments allow participants to create, view, and manipulate public comments and other actions and private comments and other actions addressed specifically to individual participants, but prevent participants from viewing comments addressed only to one or more other participants. In some embodiments, the document may be distributed to participants via whatever means are convenient. The document typically contains knowledge of a comment repository holding comments submitted by all participants which eliminates a need for a comment discovery mechanism. Some embodiments include downloading comments and other data from a repository, identifying which comments and other data is intended for display to a viewing participant, and displaying the identified comments and other data. These and other embodiments are described in detail below.

In the following detailed description, reference is made to the accompanying drawings that form a part hereof, and in which is shown by way of illustration specific embodiments in which the inventive subject matter may be practiced. These embodiments are described in sufficient detail to enable those skilled in the art to practice them, and it is to be understood that other embodiments may be utilized and that structural, logical, and electrical changes may be made without departing from the scope of the inventive subject matter. Such embodiments of the inventive subject matter may be referred to, individually and/or collectively, herein by the term “invention” merely for convenience and without intending to voluntarily limit the scope of this application to any single invention or inventive concept if more than one is in fact disclosed.

The following description is, therefore, not to be taken in a limited sense, and the scope of the inventive subject matter is defined by the appended claims.

The functions or algorithms described herein are implemented in hardware, software or a combination of software and hardware in one embodiment. The software comprises computer executable instructions stored on computer readable media such as memory or other type of storage devices. Further, described functions may correspond to modules, which may be software, hardware, firmware, or any combination thereof. Multiple functions are performed in one or more modules as desired, and the embodiments described are merely examples. The software is executed on a digital signal processor, ASIC, microprocessor, or other type of processor operating on a system, such as a personal computer, server, a router, or other device capable of processing data including network interconnection devices.

Some embodiments implement the functions in two or more specific interconnected hardware modules or devices with related control and data signals communicated between and through the modules, or as portions of an application-specific integrated circuit. Thus, the exemplary process flow is applicable to software, firmware, and hardware implementations.

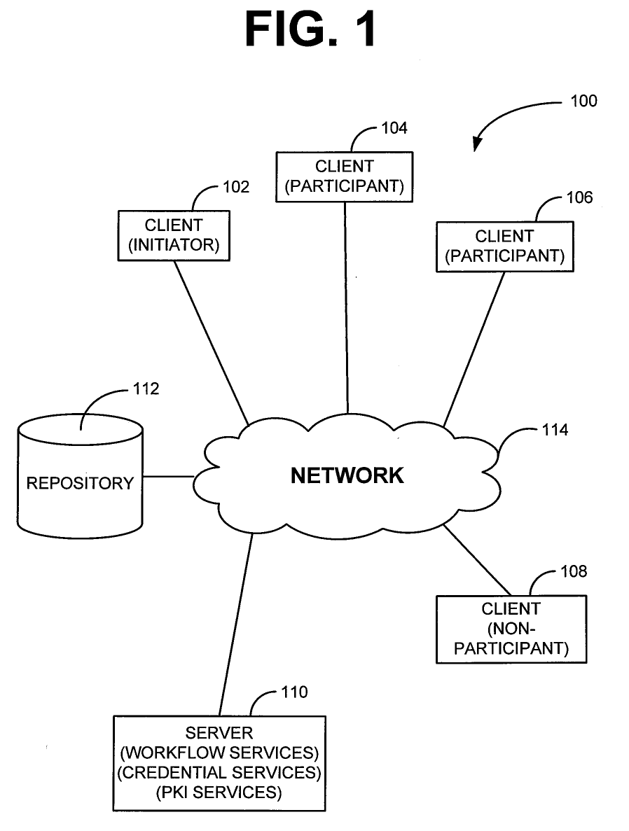

FIG. 1 is a block diagram of a system 100 according to an example embodiment. The system includes clients 102, 104, 106, and 108 connected to a network 114. In some embodiments, the network 114 may also include one or more servers 110 that offer services over the network 114, such as workflow services and user credential services. Credential services may include user credentialing, public key infrastructure, and other services. In some embodiments, a collaboration repository 112 is also connected to the network. The client 102 in some embodiments may be an initiator of a workflow process, such as a document review, a data collection process through an electronic form, or other process. The client 102 in such embodiments establishes, or already has established, an account to utilize the workflow services of the server 110.

In an example document review workflow, the client 102 initiator creates or otherwise possesses a document that is to be the subject of a document review workflow process. The client 102 initiator submits a request to instantiate a new workflow process over the network 114 to the server 110 workflow services. The workflow services process the request and, assuming the workflow services verify the identity and permission of the client 102 initiator to initiate a workflow process, returns a workflow process identifier, or other identifier, over the network 114 to the client 102 initiator. In some embodiments, the workflow services on the server 110 establish a record of the initiated workflow process in a data store, such as in a database on the server 110 or within the collaboration repository 112. The record of the initiated workflow may be indexed by the generated workflow process identifier to allow identification of the appropriate workflow to store and retrieve workflow data to and from as a function of the workflow process identifier. The workflow process identifier, in some embodiments, may include a symmetric encryption key that may be utilized to encrypt data sent to and decrypt data received from the workflow services on the server 110. The workflow services may also establish a location where workflow data is stored when received, also referred to as a shared workspace. Such workflow data that may be stored in a shared workspace may include data representative of document comments, commands, edits, modifications, formatting changes, additions, deletions, form data, approvals and rejections, attachments of other data elements which may include images, video, audio, text, and other documents and data.

The client 102 initiator, upon receipt of the workflow process identifier from the server 110, associates the workflow process identifier with the document by inserting up the workflow process identifier, or a representation thereof, into the document to be reviewed. The workflow process identifier may be stored in a metadata portion of the document, or another location where the key will not otherwise affect a graphical presentation of the document when displayed to a user. In some embodiments, a Uniform Resource Identifier (“URI”), such as a Uniform Resource Locator (“URL”), of the server 110 and workflow services operative thereon or the collaboration repository 112, is also embedded in the document to allow participants to properly address workflow process submissions and data retrieval requests.

At this point, the document of the document review workflow process may then be distributed, in electronic form, to workflow process participants, such as clients 104 and 106. The document may be distributed in any number of ways such as email, through a shared folder on a networked server, on a portable computer-readable medium such as a disk or memory stick, or other means capable of carrying the document in electronic form to other client computing devices.

The clients 104, 106 open the document using an appropriate application based on the document type and involved workflow services. The application extracts the workflow process identifier embedded in the document, and the URI of the server 110 or the collaboration repository 112 if embedded therein and not already known, such as may already be known through an application configuration setting. In some embodiments, the application may submit a request over the network 114 to the workflow services of the server 110 to retrieve content submitted by participants of the workflow process, such as document review comments and/or document modifications. The request, in some embodiments, includes the workflow process identifier extracted from the document. In other embodiments, the request is signed and/or encrypted using a portion of the workflow process identifier or includes other data identifying a client 102, 104, 106, 108 user.

The workflow services on the server 110 upon receipt of the request may simply retrieve the requested workflow content and send it over the network to the requesting client. However, in some embodiments, the client 102 initiator may have restricted access to submitted content. In such embodiments, a limited set of the stored workflow content or no workflow content may be sent to the requester. In such embodiments, credential services may be used in combination with client 102, 104, 106, 108 user credentials to identify comments or other data the user is authorized to receive. In other embodiments, all workflow content is provided to a requester. However, in such embodiments, individual content items not intended for all recipients may be encrypted using a public encryption key of each recipient authorized to view respective content items. In such embodiments, upon receipt of encrypted content items, the application attempts to decrypt the encrypted content items using a private key of the user and if the content items are properly decrypted, the content items are then available for viewing.

The participant clients 104, 106 may then receive input into the document, such as comments, document edits, data signifying an acceptance or rejection of the document, or other input. The participant clients 104, 106 may then upload the input to the workflow services of the server 110, or in some embodiments, directly to the collaboration repository 112. In some embodiments, the input may be uploaded to the server 110 or the repository 112 in a manner that restricts access to the input to less than all client 102, 104, 106, 108 users. In some such embodiments, a client 102, 104, 106, 108 submitting the data may identify one or more users the data is to be accessible by through use of the credential services of the server 110 to select the users who are to have access to the data or, conversely, select users who are not to have access to the data. In some of these embodiments and others, the application of a user may present a listing of users to select.

In some embodiments, the client 102, 104, 106, 108 applications may have public encryption keys of some or all of the other users or may retrieve public keys of the other users from the credential services on the server 110. In some embodiments, the public keys may be provided via a public key infrastructure service on the server. When such public keys are used, each item of data, such as a document comment or edit, may be encrypted using one or more of the public keys of users who are to have access to the data. In such embodiments, before the data is uploaded to the server 110 or repository 112, the data is encrypted using the keys of one or more users selected to have access to the data. In some embodiments, an “OR” type encryption is performed using the public keys of two or more selected users. In such embodiments, each of the two or more private keys of selected users may be used to decrypt the data upon retrieval from the server 110 or the repository 112. The data, in some embodiments, after being properly encrypted may then be uploaded by the client 102, 104, 106, 108 applications upon the occurrence of an event, such as saving of the document, selection of a menu item or action button, a publish comment event upon selection of a menu item or action button, or other event configured in the application to trigger an upload of the received input.

Client 108 is identified in FIG. 1 as a non-participant. Client 108 is not a participant due to the fact that client 108 did not receive an electronic copy of the document including the key or does not have an application installed enabled to allow the client 108 to participate in the workflow process. Assuming a client has an appropriate, workflow enabled application installed, mere possession of the document may allow the client to participate in the workflow process. This removes the need to establish user accounts and permissions for each user that may be needed or chooses to participate in a particular workflow. However, if comments or other workflow data stored on the server 110 or in the repository 112 are stored in a manner to restrict access, such as through encryption using public keys of authorized users or through association of the data to authorized user credentials, the user of the client 108 may not be able to retrieve and/or view the data. As a result, ad-hoc workflows may be established with little effort and while still providing security and confidentiality.

Thus, in various embodiments, one or more mechanisms to control access to comments may be used. These mechanisms may include one or more of user credential services to restrict or authorize individual comment viewing by users by a user id and password, limited distribution of a document, encryption using a restricted key, such as a key embedded in a particular application, and encryption and decryption using public key infrastructure keys of individual users. Other mechanisms may be used to restrict comment viewing as described and as apparent herein.

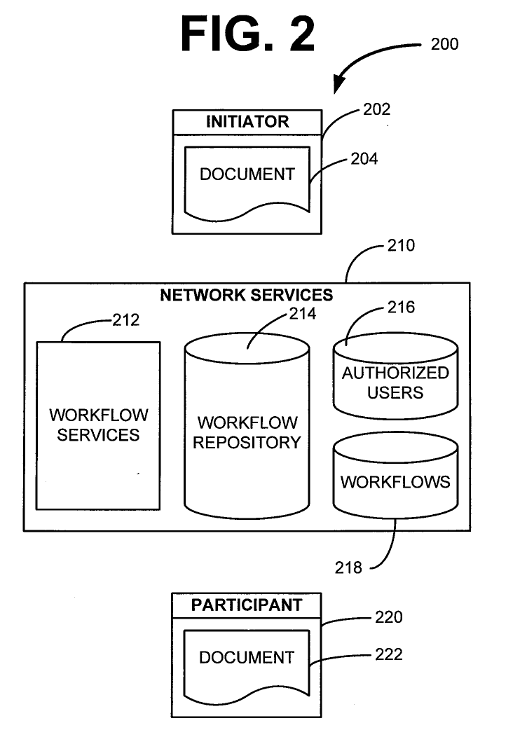

FIG. 2 is a block diagram of system 200 elements according to an example embodiment. The system 200 includes an initiator application 202, network services 210, and a participant application 220. In some embodiments, the initiator application 202 and the participant application 220 are instances of the same application. The network services 210 may be services offered on one or more servers and are illustrated as a logical grouping of services and data stores. In some embodiments, the elements illustrated as network services 210 may be physically located apart from one another in a networked computing environment.

The initiator application 202 is an application from which a document 204, or other data structure, may be setup for a workflow process utilizing the network services. In some embodiments, the initiator application 202 may also be an application providing tools that may be used to author, modify, and view documents, such as word processing documents, images, spreadsheets, videos, audio files, forms, and other document types. Once the document 204 is determined by a user to be in a state that is ready for a workflow process, such as a document review or to receive form submissions, the initiator application 202 provides tools, such as menu items and/or action buttons that may be used to setup a workflow process. Use of such tools causes the initiator application 202 to establish communication with the network services 210, such as the workflow services 212. Through communication with the network services, the initiator application receives a workflow key to embed in the document 204 and may also receive a URI of the network services, which may be used to access the workflow services in combination with the key to establish future communication with the network services, such as by workflow participants.

The network services 210 include workflow services 212, a workflow repository 214, an authorized users database 216, and a workflow database 218. The workflow services 212 include services, which may be accessed by workflow initiators to establish workflows and to retrieve workflow data stored in the workflow repository 214. The workflow services 212 also include services, which may be used by workflow participants to post data to, and optionally retrieve data from the workflow repository 214. In some embodiments, data stored in the workflow repository 214 for a designated workflow includes data representative of modifications and/or comments added to a document that is the subject of the designated workflow. An instance of the document that is the subject of the designated workflow need not be stored in the workflow repository. The data stored to the workflow repository may be optionally stored in a manner to be accessible to only a subset of authorized users, or other users that are able to access data stored in the workflow repository. In some embodiments, the data may be linked to user profiles of users allowed or not allowed to view specific items or data. In other embodiments, data stored to the workflow repository may be encrypted using a public key of each user allowed to view individual workflow data items.

An example workflow service 212 that allows an initiator to establish a workflow receives identify data, such as a user ID and password, from an initiator and queries the authorized users database 216 to verify the initiator is authorized to establish a workflow. If the initiator is authorized, the same workflow service may be used, or another workflow service may be called, to establish the workflow. Such a workflow service 212 may cause a key to be generated for the new workflow, such as through use of a Trusted Platform Module or other mechanism by which a key may be created, and that key, or a representation thereof, is inserted into a new record in the workflows database 218. In some embodiments, the new workflow record also contains a reference to a location in a workflow repository, such as a folder when the workflow repository 214 is a file server, or a database key for the workflow when the workflow repository is a database. As a result, the workflows database 218 may be queried by the key to retrieve a location of the workflow repository to determine where to store and retrieve data associated with a particular workflow.

In some embodiments, an initiator of a workflow may disable a workflow though modification of data in the workflows database 218 though the initiator application. For example, a workflows database 218 record may include a column with a Boolean value designating the corresponding workflow as enabled or disabled. If the value is disabled, no further data may be stored in the workflow repository for that workflow, but the initiator, or other, may still retrieve such data. In other embodiments, the key may removed from the record, which removes the ability of workflow participants from uniquely identifying the proper workflow to which workflow data is to be posted.

The participant application 220, as stated above, may be an instance of the same application as the initiator application 202. However, the participant application 220 need not include all of the functionality of the initiator application 202 and the initiator application 202 need not include all of the functionality of the participant application 220. In some embodiments, the participant application 220 is operative to open a document 222 and extract a workflow key therefrom. The document 222 may be an electronic instance of the document 204 designated for a workflow process within the initiator application 202. Once in possession of the extracted key, the participant application may simply wait until occurrence of an action that triggers an upload process to the network services. Such an action may be a save action, selection of an action button or menu item within a user interface of the participant application, or other action identifiable by the participant application.

Upon occurrence of such an action, the participant application 220, in some embodiments, extracts a representation of modifications to the document, such as document changes, added form data, new comments, and the like, and sends the representation to the network services. In some embodiments, the representation sent to the network services includes the key, which is used by the network services to index into the workflows database 218 to identify the specific workflow for which the data is applicable. In other embodiments, the representation of document changes is signed using the key and sent to the network services 210. The workflow services 212, in such embodiments, include a service to parse the signing and attribute the data to a workflow key stored in the workflows database 218. As discussed above with regard to the initiator application 202, the participant application 220 may also store workflow data in the workflow repository 214 in a manner to restrict access to the data.

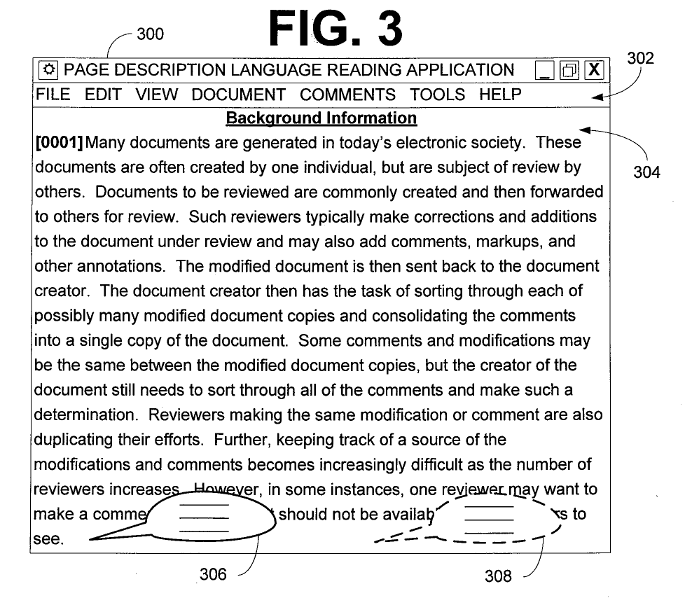

FIG. 3 is a user interface 300 illustration according to an example embodiment. The user interface 300 is an example user interface of a computer application within which a user may view a document submitted for review via a collaboration repository, such as is illustrated and described with regard to FIG. 1. In some embodiments, the user interface 300 is provided by a page description language reading application, such as one of the ACROBAT® or ACROBAT® READER applications available from ADOBE SYSTEMS, INC. of San Jose, Calif. The page description language, in some embodiments, is the PORTABLE DOCUMENT FORMAT (“PDF”), also of ADOBE SYSTEMS, INC.

The user interface 300 may include menu items 302 and a document presentation area 304. An application user may manipulate controls within the user interface 300 to add a comment 306 or otherwise markup a document, or other content item, displayed in the document presentation area 304. The application may also retrieve comments stored on a collaboration server, by workflow services, or from another location or service as may be identified within a document displayed within the document presentation area 304. A collaboration server, or other location where comments are to be retrieved from, may be set as an application configuration setting, entered by a user, or specified within the document itself, such as in document metadata. The metadata may also identify a specific collaboration session of the document.

In some embodiments, a collaboration server may hold two comments 306, 308 associated with the document presented in the document presentation area 304. One of the comments 306 may be stored in a manner to allow a user to view the comment 306 and the other comment 308 may be stored in a manner that prevents this particular user from viewing the comment 308. However, another user may be able to view the comment 308 and not the comment 306. Yet other viewers may or may not be able to view both comments 306 and 308.

In a first of such embodiments, the application may retrieve both comments 306, 308 and find that the comments are encrypted. The application may use a private encryption key of the user of the application to decrypt the comments 306, 308 and find that the comment 306 is properly decrypted and the comment 308 is not properly decrypted. The comment 306 in such instances will be displayed and the comment 308 will not be displayed. The application may determine if the comments 306, 308 are properly decrypted using a checksum function after the respective comments 306, 308 are decrypted.

In a second of such embodiments, when the application retrieves the comments 306, 308, the application only retrieves the comment 306 which the user is allowed to view. In some such embodiments, the collaboration repository, or server service providing access thereto, retrieves only comments stored in an associative manner to the user. As a result, the user is not aware that the comment 308 exists.

In a third of such embodiments, when the application retrieves the comments 306, 308, the application determines which comments a particular application user is authorized to view. In such embodiments, the comments 306, 308 may include data identifying users who are authorized to view them. The comments 306, 308 may also be encrypted. If encrypted, the comments 306, 308 are first decrypted, such as by using a private key of the user or an encryption key of the application. Then the application evaluates the data identifying the users authorized to view each comment 306, 308 and displays only the comments the particular application user is authorized to view. In some embodiments, there is no data identifying authorized users for a particular comment. In such embodiments, the comment will be viewable to all users.

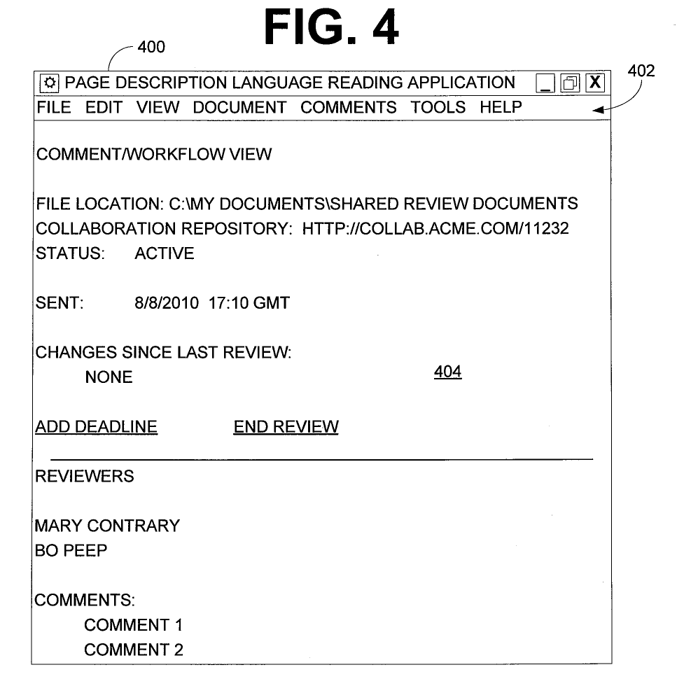

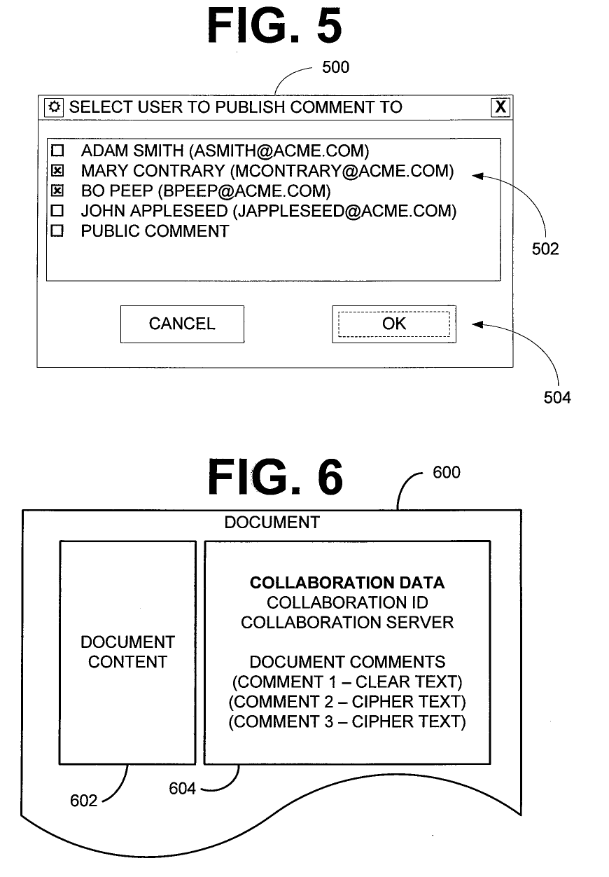

FIG. 4 is a user interface 400 illustration according to an example embodiment. The user interface 400 includes menu items 402 and a comment/workflow view 404. The comment/workflow view 404 and menu items 402 allow a user to view data related to a document submitted for review, such as the document displayed in FIG. 3. The data viewable through the user interface 400 may be workflow data, comments, approvals, rejections, a listing of reviewers, and other data associated with a document under review or submitted to another workflow process. The user interface 400 and the user interface 300 of FIG. 3, through use of menu items 402, 302 and other user interface 400, 300 controls may allow a user to enter comments, edit and markup a document, approve or reject a document, and perform other workflow and review functions. Once a comment or other data or action is placed, a user may designate other users who are able to view and not view the received comment or other data or action. In some embodiments, a user may simply select a menu item designating the comment or other data as publicly available or available only to that user. Some embodiments may also provide a user interface through which a user may enter or select users who are able to view or not view the comment or other data. FIG. 5 provides an example of such a user interface.

FIG. 5 is a user interface 500 illustration according to an example embodiment. The user interface 500 may be displayed following a user entering a comment or other document edit or modification, prior to or as part of submitting such data to a collaboration repository, or other time based on the specifics of a particular embodiment or when desired by a user. The user interface 500 provides a listing 502 of users from which to select to have access to a comment or other collaboration repository submission. A user may select users from the listing 502 of users and submit the selections by selecting the “OK” action button.

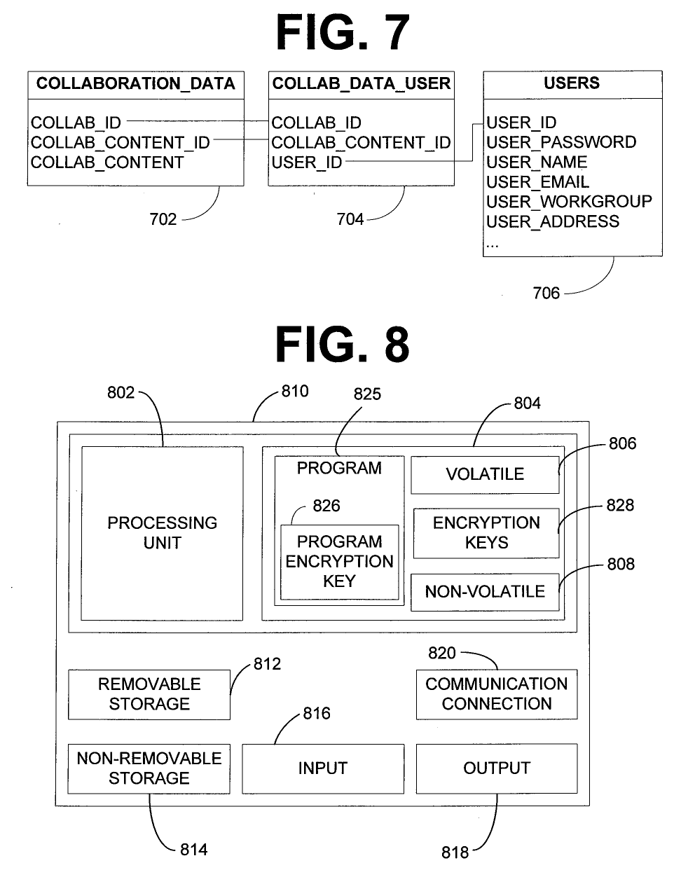

In some embodiments, the list of users 502 is populated by retrieving data from a server including credential data of users within an organization, such as a company or workgroup. The credential data may include user names, email addresses, ids, public keys, or other data which may be used to identify users and/or secure collaboration repository data. In some embodiments, a public key of users selected in the list of users 502 is used to encrypt data to be sent to the collaboration repository. Such encryption may be individually performed using a public key of each selected user or using all of the public keys of the selected users though an ORing encryption method. In other embodiments, when data is to be submitted to the collaboration server, the application encrypts the data using a key of the application that is also held by other instances of the application and stores the data on the collaboration server in association with data of the selected users. Such an association may be made in a manner as is illustrated in FIG. 7 or other associative manner.

FIG. 6 is a block diagram of a data structure 600 according to an example embodiment. The data structure 600 is an example of a document that may include collaboration data. The data structure 600 includes document content 602. The document content 602 may include document text, images, and other content and data specifying how it is to be displayed. The data structure 600 also includes collaboration data 604. The collaboration data 604 may include a collaboration identifier that identifies a collaboration session on a collaboration server or within a collaboration repository. The collaboration data 604 may also identify a location of the collaboration server or repository.

Note that a collaboration server may be a server that provides collaboration services and a collaboration repository is a storage location where collaboration data may be stored. The terms collaboration server and collaboration repository, as used in the description and claims, are intended to be interchangeable unless otherwise noted or is readily apparent.

The collaboration data 604, in some embodiments, may also include document comments. The document comments may be in clear text if they are available to all document viewers and they may be in cipher text (i.e., encrypted text) if the comments are available to less than all document viewers.

FIG. 7 illustrates related database tables 702, 704, 706 according to an example embodiment. The database tables 702, 704, 706 are tables which may be used in some embodiments to store data submitted with regard to a document review or other workflow process. The database tables 702, 704, 706 may be included within a collaboration repository. Although illustrated and described as tables, the database tables 702, 704, 706 may alternatively be flat files of text that provide the same relationships. The data in the database tables 702, 704, 706 may be stored in a markup language, such as extensible markup language (“XML”) or in another form depending on the requirements of the particular embodiment.

The database tables 702, 704, 706 include a COLLABORATION_DATA table 702. The COLLABORATION_DATA table 702 includes columns COLLAB_ID which identifies a collaboration session, COLLAB_CONTENT_ID which identifies the specific row in the COLLABORATION_DATA table 702, and a COLLAB_CONTENT which holds submitted collaboration data such as comments, markups, modification, and other data. In embodiments where submitted collaboration data is encrypted using public keys of users authorized to view the collaboration data, the COLLABORATION_DATA table 702 is the only table needed.

In other embodiments, such as embodiments where submitted collaboration data is associated with user ids of users authorized to view submitted collaboration data, further tables are needed for example, the USERS table 706 which includes data identifying users and the COLLAB_DATA_USERS table 704 which links the COLLABORATION_DATA table 702 to the USERS table 706. Thus, COLLABORATION_DATA table 702 rows may be linked to users defined in the USERS 706 table to allow respective users to view submitted collaboration data while preventing other users that are not linked from viewing it.

FIG. 8 is a block diagram of a computing device according to an example embodiment. In one embodiment, multiple such computer systems are utilized in a distributed network to implement multiple components in a transaction-based environment. Object oriented and service oriented architectures may be used to implement such functions and communicate between the multiple systems and components. One example computing device in the form of a computer 810, may include a processing unit 802, memory 804, removable storage 812, and non-removable storage 814, each of which may be interconnected with a bus. Memory 804 may include volatile memory 806 and non-volatile memory 808. Computer 810 may include—or have access to a computing environment that includes—a variety of computer-readable media, such as volatile memory 806 and non-volatile memory 808, removable storage 812 and non-removable storage 814. Computer storage includes random access memory (RAM), read only memory (ROM), erasable programmable read-only memory (EPROM) & electrically erasable programmable read-only memory (EEPROM), flash memory or other memory technologies, compact disc read-only memory (CD ROM), Digital Versatile Disks (DVD) or other optical disk storage, magnetic cassettes, magnetic tape, magnetic disk storage or other magnetic storage devices, or any other medium capable of storing computer-readable instructions. Computer 810 may include or have access to a computing environment that includes input 816, output 818, and a communication connection 820. The computer may operate in a networked environment using a communication connection to connect to one or more remote computers, such as database servers. The remote computer may include a personal computer (PC), server, router, network PC, a peer device or other common network node, or the like. The communication connection may include a Local Area Network (LAN), a Wide Area Network (WAN), or other networks.

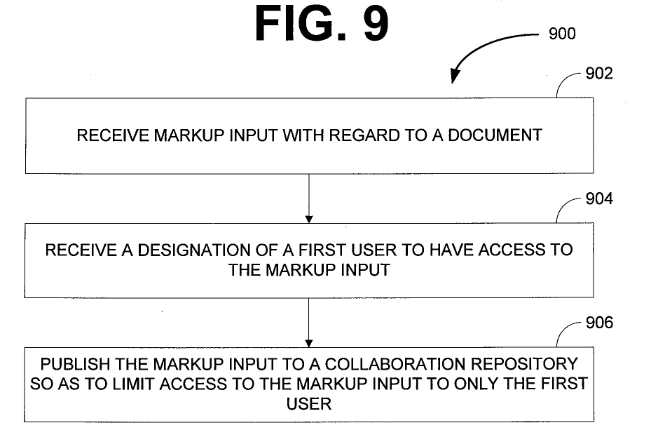

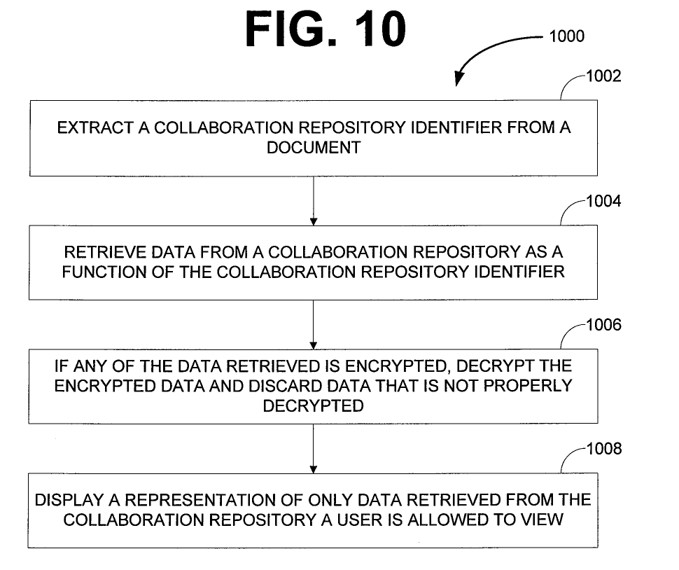

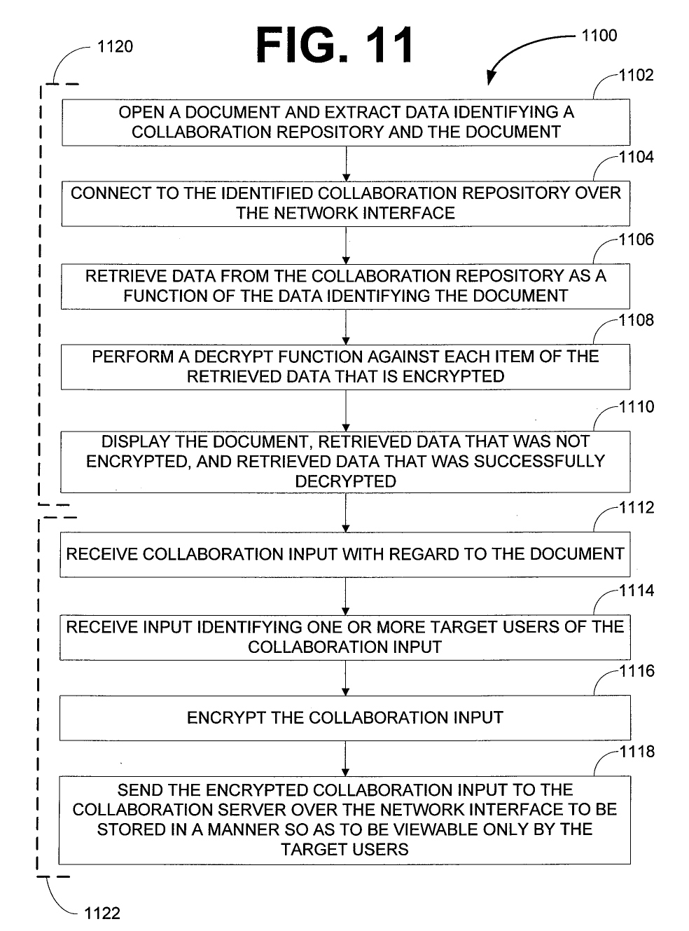

Computer-readable instructions stored on a computer-readable medium are executable by the processing unit 802 of the computer 810. A hard drive, CD-ROM, and RAM are some examples of articles including a computer-readable medium. For example, a computer program 825 capable of displaying a page description language document, word processing document, spreadsheet workbook, or other file type may be encoded in the memory 804 and/or on another of the computer-readable mediums of the computer 810. The program 825 may include a program encryption key 826 that is common to all instances of the program. The program may also, or alternatively, use one or more other encryption keys 828 stored in the memory 804. The encryption keys 828 may include a public/private encryption key of a user of the program 825 or computer 810. The encryption keys 828 may also include public encryption keys of other users. The program 825, in some embodiments, includes instructions which may be executed by the processing unit 802 to perform one or more of the methods illustrated and described with regard to FIG. 9, FIG. 10, and FIG. 11.

FIG. 9 is a block flow diagram of a method 900 according to an example embodiment. The method 900 may be performed in some embodiments to receive input into a document, such as a comment or other markup, and communicate the received input to other users while limiting which users may view the input. The method 900 includes receiving 902 markup input with regard to a document, receiving 904 a designation of a first user to have access to the markup input, and publishing 906 the markup input to a collaboration repository to limit access to the markup input to only the first user. In some embodiments, the method 900 includes encrypting markup input prior to publishing 906 it. The encrypting of the markup input may be performed using a public key of the first user. Receiving 904 the designation of the first user may include retrieving data representative of users including the first user, such as from a server holding user credential data. At least a portion of the retrieved data is then presented in a user interface and the designation of the first user may be received 904 via the user interface. FIG. 5 includes an illustration of one example of such a user interface.

Some embodiments of the method 900 further include receiving a designation of a second user to have access to the markup input and encrypting the markup input as a function of public keys of both the first and second users. In such embodiments, publishing 906 the markup input to the collaboration repository is performed to limit access to the markup input to only the first and second users.

In some other embodiments, access to the markup input is available to the first user from the collaboration repository only upon verification of the first user's identity. The first user's identity, in such embodiments, may be verified as a function of a user ID and password of the first user.

FIG. 10 is a block flow diagram of a method 1000 according to an example embodiment. The method 1000 is an example of how a document submitted for review or another workflow process may be opened by an application and collaboration data retrieved and presented. The method 1000 includes extracting 1002 a collaboration repository identifier from a document and retrieving 1004 data from a collaboration repository as a function of the collaboration repository identifier. Some embodiments of the method 1000 then includes displaying 1008 a representation of only data retrieved from the collaboration repository a user is allowed to view. In some embodiments, the user is allowed to view all the retrieved 1004 data. For example, the collaboration repository may filter out data or retrieves only data the user is allowed view.

In other embodiments, the some or all of the data retrieved 1004 wherein at least one data item retrieved from the collaboration repository is encrypted. In such embodiments, the method 1000 includes decrypting 1006 the encrypted data item as a function of a private key of a user. If any item of the data is not properly decrypted, which may be determined using a checksum or hashing functions, that data may be discarded.

FIG. 11 is a block flow diagram of a method 1100 according to an example embodiment. The method 1100 includes two portions 1120, 1122. The first portion 1120 is an example of how a document may be opened and collaboration data retrieved and displayed within the document. The second portion includes receiving and sharing 1122 collaboration input.

The method 1100, in some embodiments includes opening 1102 a document and extracting data identifying a collaboration repository and the document. The method 1100 further includes connecting 1104 to the identified collaboration repository over the network interface and retrieving 1106 data from the collaboration repository as a function of the data identifying the document. Decrypting is then performed 1108 against each item of the retrieved data that is encrypted. The method 1100 then displays 1110 the document, retrieved data that was not encrypted, and retrieved data that was successfully decrypted.

Some embodiments of the method 1100 further include receiving 1112 collaboration input with regard to the document and receiving 1114 input identifying one or more target users of the collaboration input. The input may then be encrypted 1116. The method 1100 may then send 1118 the encrypted collaboration input to the collaboration server over the network interface to be stored in a manner to be viewable only by the target users.

It is emphasized that the Abstract is provided to comply with 37 C.F.R. §1.72(b) requiring an Abstract that will allow the reader to quickly ascertain the nature and gist of the technical disclosure. It is submitted with the understanding that it will not be used to interpret or limit the scope or meaning of the claims.

In the foregoing Detailed Description, various features are grouped together in a single embodiment to streamline the disclosure. This method of disclosure is not to be interpreted as reflecting an intention that the claimed embodiments of the inventive subject matter require more features than are expressly recited in each claim. Rather, as the following claims reflect, inventive subject matter lies in less than all features of a single disclosed embodiment. Thus, the following claims are hereby incorporated into the Detailed Description, with each claim standing on its own as a separate embodiment.

It will be readily understood to those skilled in the art that various other changes in the details, material, and arrangements of the parts and method stages which have been described and illustrated in order to explain the nature of the inventive subject matter may be made without departing from the principles and scope of the inventive subject matter as expressed in the subjoined claims.

What is claimed is:

1-8. (canceled)

9. A non-transitory computer-readable medium, with instructions thereon, which when executed cause a computer to:
extract a collaboration repository identifier from a locally stored document, the locally stored document including a document content portion and a collaboration data portion that includes the collaboration repository identifier and collaboration data;
retrieve collaboration data from a remote collaboration repository as a function of the collaboration repository identifier;
display, within a view of the locally stored document, a representation of only collaboration data from the collaboration portion of the locally stored document and collaboration data retrieved from the remote collaboration repository a user is allowed to view, the collaboration data retrieved from the remote collaboration repository including data representative of modifications and comments added by other users to their respective instances of the locally stored document but not to the locally stored document itself;
receive collaboration input with regard to the locally stored document;
store the retrieved collaboration data and the received collaboration input in the collaboration data portion of the locally stored document; and
send at least the received collaboration input to the remote collaboration repository.

10. The non-transitory computer-readable medium of claim 9, wherein the collaboration repository identifier identifies at least one of:
the document;
a collaboration repository session; and
a network location of the collaboration repository.

11. The non-transitory computer-readable medium of claim 9, wherein at least one data item retrieved from the collaboration repository is encrypted and the instructions when further executed cause the computer to:
decrypt the encrypted data item as a function of a private key of the user; and
discard the data item if not properly decrypted.

12. The non-transitory computer-readable medium of claim 9, wherein the instructions when further executed cause the computer to:
request user credentials from the user;
when retrieving data from the collaboration repository, provide the user credentials; and
wherein the data retrieved from the collaboration server is retrieved as a function of the user credentials to obtain only data from the collaboration repository the user is allowed to view.

13. The non-transitory computer-readable medium of claim 12, wherein the instructions when further executed, cause the computer to:
decrypt the retrieved data using an encryption key of an application within which the retrieved data is to be displayed.

14. (canceled)

15. A system comprising:
a bus;
a network interface coupled to the bus;
a processor coupled to the bus; and
a memory coupled to the bus and holding instructions of a computer application, the instructions operable on the processor to:
open a locally stored document and extract data identifying a remote collaboration repository and data identifying a document of which the locally stored document is a copy, the locally stored document including a content portion and a collaboration data portion that includes the remote collaboration repository identifier and collaboration data;
connect to the identified remote collaboration repository over the network interface;
retrieve collaboration data from the remote collaboration repository as a function of the data identifying the document, the remote collaboration repository storing collaboration data representative of modifications and comments added by other users to their respective instances of the locally stored document but not the locally stored document itself;
perform a decrypt function against each item of the retrieved data that is encrypted;
display, within a view of the locally stored document, a representation of collaboration data from the collaboration portion of the locally stored document, retrieved collaboration data that was not encrypted, and retrieved collaboration data that was successfully decrypted;
receive collaboration input with regard to the locally stored document;
store the retrieved collaboration data and the received collaboration input in the collaboration data portion of the locally stored document; and
send at least the received collaboration input to the remote collaboration repository.

16. The system of claim 15, wherein the decrypt function is performed as a function of an encryption key of a user of the system.

17. The system of claim 15, wherein the instructions in the memory are further operable on the processor to:
receive collaboration input with regard to the locally stored document;
receive input identifying one or more target users of the collaboration input;
encrypt the collaboration input; and
send the encrypted collaboration input to the collaboration server over the network interface to be stored in a manner to be viewable only by the target users.

18. The system of claim 17, wherein the collaboration input is encrypted as a function of a public key of each identified target user.

19. The system of claim 17, wherein collaboration input is encrypted as a function of an encryption key included within the computer application.

20. The system of claim 15, wherein the computer application is a page description language document presentation application.
